(19) United States
(12) Patent Application Publication
(10) Pub. No.: US 2013/0059220 A1
(43) Pub. Date: Mar. 7, 2013

(54) FUEL CELL SYSTEM AND DRIVING METHOD THEREOF

(71) Applicants: Dong-Rak Kim, Yongin-si (KR); Hyun Kim, Yongin-si (KR); Young-Jae Kim, Yongin-si (KR); Jung-Min Kwon, Yongin-si (KR); Lei Hu, Yongin-si (KR)

(72) Inventors: Dong-Rak Kim, Yongin-si (KR); Hyun Kim, Yongin-si (KR); Young-Jae Kim, Yongin-si (KR); Jung-Min Kwon, Yongin-si (KR); Lei Hu, Yongin-si (KR)

(21) Appl. No.: 13/402,739

(22) Filed: Feb. 22, 2012

(30) Foreign Application Priority Data
Sep. 7, 2011 (KR) 10-2011-0090715

(51) Int. Cl. H01M 8/04; H01M 8/24

(52) U.S. Cl. 429/431; 429/430; 429/432

(57) ABSTRACT

A fuel cell system for supplying power to a load includes: a plurality of fuel cell stacks; a plurality of DC/DC converters coupled to the plurality of fuel cell stacks; and a stack controller for estimating performance of the respective fuel cell stacks according to current amounts of the plurality of fuel cell stacks, and for controlling power converting efficiency of the respective DC/DC converters according to the performance of the fuel cell stacks to control output power generated by the fuel cell stacks.

### CROSS-REFERENCE TO RELATED APPLICATION

This application claims priority to and the benefit of Korean Patent Application No. 10-2011-0090715, filed in the Korean Intellectual Property Office, on Sep. 7, 2011, the entire content of which is incorporated herein by reference.

### BACKGROUND

1. Field

The following description relates to a fuel cell system and a driving method thereof. More particularly, the following description relates to a fuel cell system for efficiently controlling a plurality of fuel cell stacks and a driving method thereof.

2. Description of Related Art

A fuel cell is a device for electrochemically producing power by using fuel (hydrogen or reformed gas) and an oxidizing agent (oxygen or air). Namely, the fuel cell directly converts the fuel (hydrogen or reformed gas) and the oxidizing agent (oxygen or air) that are continuously supplied from the exterior into electrical energy through an electrochemical reaction.

To increase output in the fuel cell system, the number of unit cells included in a fuel cell stack is increased or the fuel cell stack is configured by using a large membrane electrode assembly (MEA).

When the number of unit cells included in the fuel cell stack is increased or a large MEA is used, subsequent problems may occur. As a first example, the fuel can be supplied to a plurality of unit cells in a non-uniform manner, and great deviation between the unit cells can be generated. As a second example, a fuel supply device that can produce a high flow rate is needed, so power consumption of the fuel cell system is increased and equipment cost is increased. As a third example, when performance of some unit cells included in the fuel cell stack is deteriorated as the fuel cell system is driven, the whole package of the fuel cell stack must be replaced. As a fourth example, the fuel cell stack is driven with high power for a small load power so performance and cycle life of the fuel cell stack can be deteriorated quickly.

The above information disclosed in this Background section is only for enhancement of understanding of the background of the invention and therefore it may contain information that does not form the prior art that is already known in this country to a person of ordinary skill in the art.

### SUMMARY

An aspect of an embodiment of the present invention is directed toward a fuel cell system for guaranteeing performance and cycle life while being driven with high power, and a driving method thereof.

An exemplary embodiment of the present invention provides a fuel cell system for supplying power to a load, including: a plurality of fuel cell stacks; a plurality of DC/DC converters coupled to (e.g., connected to) the plurality of fuel cell stacks; and a stack controller for estimating performance of the respective fuel cell stacks according to current amounts of the plurality of fuel cell stacks, and for controlling power converting efficiency of the respective DC/DC converters according to the performance of the fuel cell stacks to control output power generated by the fuel cell stacks.

In one embodiment, each of the DC/DC converters includes: a first comparator for outputting a differential value between a voltage of a corresponding fuel cell stack and a corresponding balance signal; a power transformer including a switch for receiving a voltage of the corresponding fuel cell stack, for generating output power by converting the voltage of the corresponding fuel cell stack according to a switching operation of the switch, and for supplying power to the load connected to an output end; a first dividing resistor including a first end connected to the output end of the power transformer; a second dividing resistor including a first end connected to a second end of the first dividing resistor and a second end connected to an output end of the first comparator; a second comparator for outputting a differential value between a voltage at a node to which the first dividing resistor and the second dividing resistor are connected and a reference voltage; and a switch controller for controlling a duty of the switch according to an output signal of the second comparator.

In one embodiment, the reference voltage represents a set or predetermined voltage corresponding to the voltage at the node to which the dividing resistor and the second dividing resistor are connected when performance of the fuel cell stack is normal.

In one embodiment, the fuel cell system further includes a plurality of current sensors for measuring current amounts of the fuel cell stacks to transmit an analog current amount signal to the stack controller.

In one embodiment, the stack controller includes: an analog-digital converter for converting the analog current amount signal into a digital current amount signal; a processor for estimating performance of the fuel cell stacks based on the digital current amount signal, and for generating a digital balance signal for power converting efficiency of the DC/DC converters according to performance of the fuel cell stacks; and a digital-analog converter for converting the digital balance signal into an analog balance signal and for transmitting the analog balance signal to the DC/DC converters.

The stack controller is configured to drive part of the fuel cell stacks according to load power required by the load.

Another embodiment of the present invention provides a fuel cell system including: a current sensor for generating a current amount signal by measuring a current amount of a fuel cell stack; a stack controller for estimating performance of the fuel cell stack according to the current amount signal, and for outputting a balance signal to control output power of the fuel cell stack according to performance of the fuel cell stack; and a DC/DC converter for controlling power converting efficiency according to the balance signal.

In one embodiment, the DC/DC converter includes: a first comparator for outputting a differential value between a voltage of the fuel cell stack and the balance signal; a power transformer including a switch for receiving a voltage of the fuel cell stack, and for converting the voltage of the fuel cell stack according to a switching operation of the switch to generate output power at a first node to which a load is connected and to supply power to the load; a first dividing resistor including a first end connected to the first node and a second end connected to a second node; a second dividing resistor including a first end connected to the second node and a second end connected to an output end of the first comparator; a second comparator for outputting a differential value between a voltage at the second node and a reference voltage; and a switch controller for controlling output power of the power transformer according to an output signal of the second comparator.

In one embodiment, the reference voltage represents a set or predetermined voltage corresponding to the voltage at the second node when performance of the fuel cell stack is normal.

Yet another embodiment of the present invention provides a method for driving a fuel cell system, including: generating a current amount signal by measuring a current amount of a fuel cell stack; estimating performance of the fuel cell stack according to the current amount signal; generating a balance signal for controlling output power of the fuel cell stack according to performance of the fuel cell stack; and controlling power converting efficiency of a DC/DC converter connected to the fuel cell stack according to the balance signal.

In one embodiment, the controlling of power converting efficiency of the DC/DC converter includes: outputting a first differential value by comparing the balance signal and a voltage of the fuel cell stack; outputting a second differential value by comparing a reference voltage and a voltage generated at a second node by a voltage difference between the first differential value and a voltage that is converted from the voltage of the fuel cell stack and is output to a first node connected to a load; and controlling the voltage output to the first node according to the second differential value.

In one embodiment, the reference voltage represents a set or predetermined voltage corresponding to a voltage at the second node when performance of the fuel cell stack is normal.

According to the embodiments of the present invention, low-output drive is available as well as high-power drive in correspondence to a load's required power, and driving efficiency of the fuel cell system is improved. A plurality of fuel cell stacks are used so the fuel cell stack can be configured by using a small-area MEA, and generation of deviation between the unit cells caused by non-uniform fuel supply is reduced or prevented. A fuel supply device with a great flow rate is not needed so an equipment cost increase for the fuel cell system becomes controllable. The fuel cell stack of which performance is deteriorated from among a plurality of fuel cell stacks can be selectively replaced, and performance maintenance of the fuel cell system is simplified. The outputs of the respective fuel cell stacks are controlled corresponding to the performance of the fuel cell stack thereby improving performance and cycle-life of the fuel cell stacks.

### BRIEF DESCRIPTION OF THE DRAWINGS

FIG. 1 shows a block diagram of a fuel cell system according to an exemplary embodiment of the present invention.

FIG. 2 shows a block diagram of a controller of a fuel cell system according to an exemplary embodiment of the present invention.

FIG. 3 shows a circuit diagram of a DC/DC converter of a fuel cell system according to an exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Constituent elements having the same structures throughout the embodiments are denoted by the same reference numerals and are described in a first exemplary embodiment. In the subsequent exemplary embodiments, only constituent elements other than the same constituent elements are described in more detail.

Accordingly, the drawings and description are to be regarded as illustrative in nature and not restrictive, and like reference numerals designate like elements throughout the specification.

Throughout this specification and the claims that follow, when it is described that an element is “coupled” to another element, the element may be “directly coupled” to the other element or “electrically coupled” to the other element through one or more third elements. In addition, unless explicitly described to the contrary, the word “comprise” and variations such as “comprises” or “comprising” will be understood to imply the inclusion of stated elements but not the exclusion of any other elements.

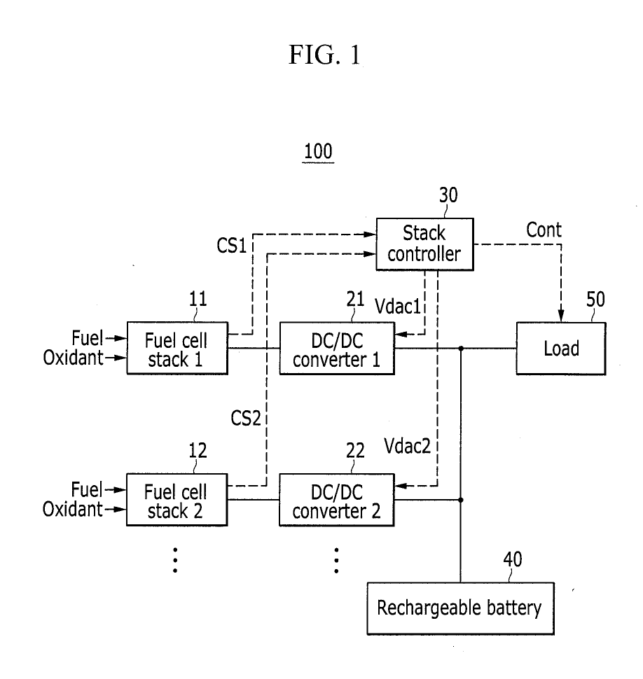

FIG. 1 shows a block diagram of a fuel cell system according to an exemplary embodiment of the present invention.

Referring to FIG. 1, the fuel cell system 100 includes a plurality of fuel cell stacks 11 and 12, a plurality of DC/DC converters 21 and 22 connected to the plurality of fuel cell stacks 11 and 12, a rechargeable battery 40 connected to the plurality of DC/DC converters 21 and 22, a load 50 using output power of the plurality of fuel cell stacks 11 and 12, and a stack controller 30 for controlling the fuel cell stacks 11 and 12.

For ease of description, the fuel cell system 100 is assumed to include a first fuel cell stack 11 and a second fuel cell stack 12. The number and kinds of fuel cell stacks included in the fuel cell system 100 is not restricted thereto.

The first fuel cell stack 11 and the second fuel cell stack 12 receive fuel from a fuel storage unit and receive an oxidant from an oxidant supplier to generate electrical energy. The fuel used by the fuel cell system 100 includes hydrocarbon-based liquid or gas fuel such as methanol, ethanol, natural gas, or LPG. The fuel cell system 100 can use oxygen gas stored in an individual storage member or air as an oxidant that reacts with hydrogen.

The first fuel cell stack 11 and the second fuel cell stack 12 can generate electrical energy using various suitable methods. For example, the polymer electrode membrane fuel cell (PEMFC) method or the direct oxidation fuel cell method can be used. The polymer electrode membrane fuel cell method reforms fuel to generate hydrogen, and allows hydrogen and oxygen to electrochemically react and thereby generate electrical energy. The direct oxidation fuel cell method generates electrical energy through a direct reaction of liquid or gas fuel with oxygen in the unit cell. The first fuel cell stack 11 and the second fuel cell stack 12 can generate electrical energy by using the same or different methods.

The first fuel cell stack 11 is connected to the first DC/DC converter 21, and the second fuel cell stack 12 is connected to the second DC/DC converter 22.

The first DC/DC converter 21 converts DC power of a first level output by the first fuel cell stack 11 into DC power of a second level and transmits this converted power to the rechargeable battery 40 or the load 50. The second DC/DC converter 22 converts DC power of a first level output by the second fuel cell stack 12 into DC power of a second level and transmits this converted power to the rechargeable battery 40 or the load 50.

The rechargeable battery 40 is electrically connected to the first fuel cell stack 11 and the second fuel cell stack 12 through the first DC/DC converter 21 and the second DC/DC converter 22, and it is charged with the electrical energy generated by the first fuel cell stack 11 and the second fuel cell stack 12. The rechargeable battery 40 is connected to the load 50, and the charged electrical energy is used by the load 50. A nickel-cadmium battery, a nickel metal hydride battery, a lithium ion battery, a lithium polymer battery, a lead storage battery, or an alkaline storage battery can be used for the rechargeable battery 40. The lead storage battery uses lead peroxide as a cathode, lead as an anode, and sulfuric acid as an electrolyte solution. The alkaline storage battery uses nickel hydroxide as a cathode, cadmium as an anode, and an alkaline solution as an electrolyte solution. The rechargeable battery 40 can be replaced with various other suitable power storage devices.

The load 50 is electrically connected to the first fuel cell stack 11 and the second fuel cell stack 12 through the first DC/DC converter 21 and the second DC/DC converter 22, and it uses the electrical energy generated by the first fuel cell stack 11 and the second fuel cell stack 12 and the electrical energy stored (charged) in the rechargeable battery 40. The load 50 can be realized through various suitable electrical devices such as a vehicle motor, an inverter for inverting DC power into AC power, and heaters as home appliances.

The stack controller 30 controls the first fuel cell stack 11, the second fuel cell stack 12, the first DC/DC converter 21, the second DC/DC converter 22, and the load 50. In detail, the controller 30 estimates performance of the fuel cell stacks 11 and 12, and controls power converting efficiency of the DC/DC converters 21 and 22 according to the estimated performance to control the output power generated by the fuel cell stacks 11 and 12. A mode that controls output power of each fuel cell stack according to each performance of a plurality of fuel cell stacks is called a balance mode.

The stack controller 30 receives a first current amount signal CS1 of the first fuel cell stack 11 and a second current amount signal CS2 of the second fuel cell stack 12 to estimate performance of the first fuel cell stack 11 and the second fuel cell stack 12. The stack controller 30 transmits balance signals (Vdac1, Vdac2) for controlling power converting efficiency of the first DC/DC converter 21 and the second DC/DC converter 22 to the first DC/DC converter 21 and the second DC/DC converter 22 according to performance of the first fuel cell stack 11 and the second fuel cell stack 12. The power converting efficiency of the first DC/DC converter 21 and the second DC/DC converter 22, and the output power of the respective fuel cell stacks, are controlled according to the balance signals (Vdac1, Vdac2).

For example, when the performance of the first fuel cell stack 11 is deteriorated compared to the performance of the second fuel cell stack 12, the stack controller 30 reduces power converting efficiency of the first DC/DC converter 21 or increases power converting efficiency of the second DC/DC converter 22 to increase the output of the second fuel cell stack 12 by the deterioration amount of the first fuel cell stack 11.

Also, the stack controller 30 transmits a control signal (Cont) for controlling drive of the load 50 to the load 50, and the stack controller 30 drives one or both of the first fuel cell stack 11 and the second fuel cell stack 12 according to load power required by the load 50. A mode for driving all the fuel cell stacks will be called a full mode and a mode for driving a part of the fuel cell stacks will be called a half mode. In the full mode, the stack controller 30 transmits balance signals (Vdac1, Vdac2) for converting power according to a set or predetermined power converting efficiency to the first DC/DC converter 21 and the second DC/DC converter 22. In the half mode, the stack controller 30 transmits a balance signal for outputting power to one of the first DC/DC converter 21 and the second DC/DC converter 22 to the same converter. The balance signal output by the full mode and the half mode can be a signal for turning on/off the first DC/DC converter 21 and/or the second DC/DC converter 22.

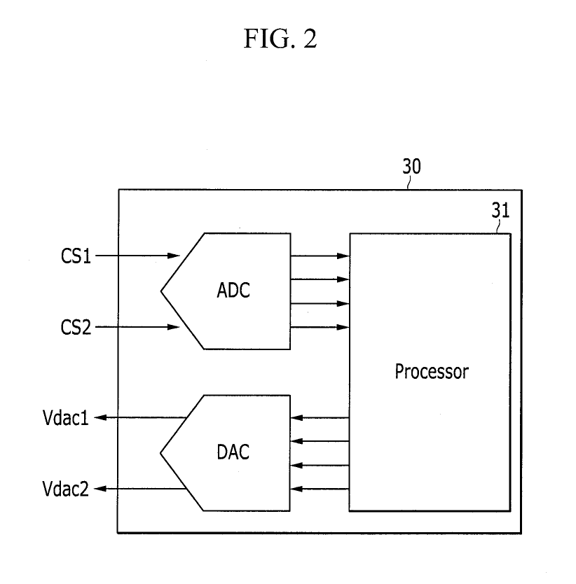

FIG. 2 shows a block diagram of a controller of a fuel cell system according to an exemplary embodiment of the present invention.

Referring to FIG. 2, the stack controller 30 of the fuel cell system 100 includes an analog digital converter (ADC), a processor 31, and a digital analog converter (DAC).

The analog digital converter (ADC) converts analog current amount signals CS1 and CS2 of a plurality of fuel cell stacks 11 and 12 into digital signals and transmits them to the processor 31. The current amount signals CS1 and CS2 represent values of the current amounts flowing from the fuel cell stacks 11 and 12. The analog digital converter (ADC) generates digital current amount signal corresponding to the values of the current amounts indicated by the current amount signals CS1 and CS2.

The processor 31 receives the digital current amount signals to generate a digital balance signal for controlling power converting efficiency of the first DC/DC converter 21 and/or the second DC/DC converter 22. The processor 31 estimates performance of the first fuel cell stack 11 and the second fuel cell stack 12 based on the digital current amount signal. The processor 31 determines that performance of the fuel cell stack is normal when the digital current amount signal is greater than a set or predetermined threshold value, and it determines that performance of the fuel cell stack is deteriorated when the digital current amount signal is less than the set or predetermined threshold value.

The processor 31 selects at least one of drive modes of the fuel cell system 100, including a balance mode, the full mode, and the half mode, and generates a digital balance signal according to the selected drive mode.

The digital analog converter (DAC) converts the digital balance signal into analog balance signals (Vdac1, Vdac2). The analog balance signals (Vdac1, Vdac2) are transmitted to the first DC/DC converter 21 and the second DC/DC converter 22. The first DC/DC converter 21 and the second DC/DC converter 22 control the power converting efficiency according to the analog balance signals (Vdac1, Vdac2). The fuel cell system 100 is driven by the selected drive mode.

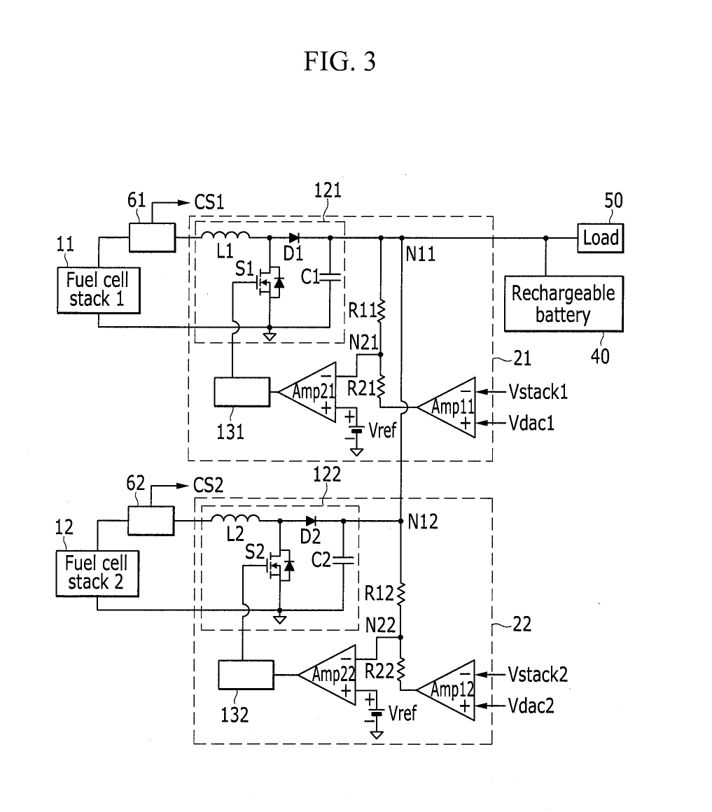

FIG. 3 shows a circuit diagram of a DC/DC converter of a fuel cell system according to an exemplary embodiment of the present invention.

Referring to FIG. 3, the first DC/DC converter 21 and the second DC/DC converter 22 of the fuel cell system 100 can be configured with the same circuit.

For ease of description, the first DC/DC converter 21 will be described and the description of the first DC/DC converter 21 is applied to the second DC/DC converter 22 in a like manner.

A first terminal of the first fuel cell stack 11 is connected to a first current sensor 61. The first current sensor 61 measures the current flowing from the first fuel cell stack 11 to generate a first current amount signal CS1. The first current sensor 61 is included in the first fuel cell stack 11 or the first DC/DC converter 21. A second current sensor 62 measures the current flowing from the second fuel cell stack 12 to generate a second current amount signal CS2. The first current amount signal CS1 and the second current amount signal CS2 are transmitted to the stack controller 30.

The first DC/DC converter 21 includes a power transformer 121, a first comparator Amp11, a second comparator Amp21, a first dividing resistor R11, a second dividing resistor R21, and a switch controller 131.

The power transformer 121 includes an inductor L1, a diode D1, a switch S1, and a capacitor C1. The inductor L1 includes a first end connected to a first terminal of the first fuel cell stack 11 and a second end connected to a first end of the diode D1. The diode D1 includes a first end connected to the second end of the inductor L1 and a second end connected to the first node N11. The first node N11 is connected to the rechargeable battery 40 and the load 50. The capacitor C1 includes a first end connected to the second end of the diode D1 and a second end connected to a second terminal of the first fuel cell stack 11. The switch S1 includes a first end connected to the second end of the inductor L1, a second end connected to the second terminal of the first fuel cell stack 11, and a gate connected to the switch controller 131. The power transformer 121 converts output power of the first fuel cell stack 11 and outputs a result to the first node N11. The power transformer 121 transforms a voltage of the first fuel cell stack 11 into output power according to a switching operation by a switch S1 to which the voltage of the first fuel cell stack 11 is input, and supplies power to the load 50 connected to an output end (i.e., the first node N11). The output power of the power transformer 121 is determined by a duty of the switch S1.

The first comparator Amp11 includes a first input end (−) for receiving a stack voltage (Vstack1) of the first fuel cell stack 11, a second input end (+) for receiving an analog balance signal (Vdac1) for the first fuel cell stack 11, and an output end for outputting a differential value of the stack voltage (Vstack1) and the balance signal (Vdac1). The stack voltage (Vstack1) of the first fuel cell stack 11 can be a measured voltage of the first fuel cell stack 11 or a set or predetermined voltage.

The first dividing resistor R11 includes a first end connected to the first node N11 and a second end connected to the second node N21. The second dividing resistor R21 includes a first end connected to the second node N21 and a second end connected to the output end of the first comparator Amp11. A voltage corresponding to a voltage difference between the voltage of the first node N11 and the output voltage of the first comparator Amp11 is divided by the first dividing resistor R11 and the second dividing resistor R21. The voltage at the second node N21 is transmitted to a first input end of the second comparator Amp21.

The second comparator Amp21 includes a first input end (−) for receiving a voltage at the second node N21, a second input end (+) for receiving a reference voltage (Vref), and an output end for outputting a differential value of the input signal. The second comparator Amp21 outputs the reference voltage (Vref) and a differential value of the voltage at the second node N21 and transmits it to the switch controller 131.

The switch controller 131 is connected to the output end of the second comparator Amp21, and controls the duty of the switch S1 according to an output signal of the second comparator Amp21. Output power of the power transformer 121 is determined by duty control of the switch S1.

A driving method for controlling an output of a fuel cell stack according to performance of the fuel cell stack will now be described with reference to FIG. 1 to 3.

Balance Mode

The first current sensor 61 measures the current flowing from the first fuel cell stack 11, and transmits a first current amount signal CS1 to the stack controller 30. The second current sensor 62 measures the current flowing from the second fuel cell stack 12, and transmits a second current amount signal CS1 to the stack controller 30.

The stack controller 30 estimates performance of the first fuel cell stack 11 based on the first current amount signal CS1, and estimates performance of the second fuel cell stack 12 based on the second current amount signal CS2. The stack controller 30 generates a first balance signal (Vdac1) and a second balance signal (Vdac2) for controlling output power of the fuel cell stacks 11 and 12 according to performance of the first fuel cell stack 11 and the second fuel cell stack 12. The stack controller 30 transmits the first balance signal (Vdac1) to the first DC/DC converter 21 and the second balance signal (Vdac2) to the second DC/DC converter 22.

Regarding the first DC/DC converter 21, the stack voltage (Vstack1) of the first fuel cell stack 11 can be a set or predetermined voltage, and the output voltage of the first comparator Amp11 is determined by the first balance signal (Vdac1). The voltage at the first node N11 represents a voltage transmitted to the rechargeable battery 40 and the load 50, and it is maintained at a substantially fixed voltage. Also, since each of the first dividing resistor R11 and the second dividing resistor R21 has a set or predetermined resistance, the voltage at the second node N21 is determined by the output voltage of the first comparator Amp11.

The reference voltage (Vref) applied to the second input end (+) of the second comparator Amp21 can be a set or predetermined voltage corresponding to the voltage at the second node N21 when performance of the first fuel cell stack 11 is normal. The voltage at the second node N21 is input to the first input end (−) of the second comparator Amp21, and the reference voltage (Vref) is input to the second input end (+). The second comparator Amp21 transmits a differential value between the voltage at the second node N21 and the reference voltage (Vref) to the switch controller 131. That is, the signal transmitted to the switch controller 131 is determined by the first balance signal (Vdac1). The switch controller 131 controls the duty of the switch S1 according to the output voltage of the second comparator Amp21.

For example, when performance of the first fuel cell stack 11 is normal, the first balance signal (Vdac1) is transmitted to the first comparator Amp11 with a voltage that is equivalent to the stack voltage (Vstack1) of the first fuel cell stack 11 or a set or predetermined voltage. When the voltage at the first node N11 is 5V, the first dividing resistor R11 and the second dividing resistor R21 have equivalent resistance, and the output voltage of the first comparator Amp11 is 0V, and the voltage at the second node N21 is 2.5V. The reference voltage (Vref) can be set to be 2.5V corresponding to the voltage at the second node N21 when performance of the first fuel cell stack 11 is normal, and the second comparator Amp21 outputs 0V that is a differential value between the voltage at the second node N21 and the reference voltage (Vref). The switch controller 131 controls the duty of the switch S1 according to the output voltage of the second comparator Amp21 so that power may be normally output by the first fuel cell stack 11.

When the performance of the first fuel cell stack 11 is deteriorated, the stack controller 30 controls a voltage level of the first balance signal (Vdac1) corresponding to performance deterioration of the first fuel cell stack 11. Assuming that a voltage level of the first balance signal (Vdac1) is generated to be greater than the voltage (Vstack1) of the first fuel cell stack 11 by 2V corresponding to performance deterioration of the first fuel cell stack 11, the output voltage of the first comparator Amp11 becomes 2V. When the output voltage of the first comparator Amp11 is 2V, the voltage at the second node N21 becomes 3.5V. The voltage at the second node N21 is 3.5V and the reference voltage (Vref) is 2.5V so the second comparator Amp21 outputs the output voltage of 1V. The switch controller 131 reduces the duty of the switch S1 according to the output voltage of the second comparator Amp2 to reduce the output power of the first fuel cell stack 11.

The stack controller 30 determines the output power of the second fuel cell stack 12 according to performance of the second fuel cell stack 12 in a like manner of determining output power of the first fuel cell stack 11 according to performance of the first fuel cell stack 11.

Accordingly, the fuel cell system 100 including a plurality of fuel cell stacks detects the current amounts output by the respective fuel cell stacks to estimate performance of the fuel cell stacks and reduce the output power corresponding to performance deterioration of the fuel cell stack. When the performances of the respective fuel cell stacks become different because of long driving of the fuel cell system 100 or an emergency, the fuel cell stacks are not individually turned on/off, but the output power is changeable according to performance of the fuel cell stacks. Therefore, the output power of the fuel cell system 100 including a plurality of fuel cell stacks can be output sequentially and stably, and the lifespan of the respective fuel cell stacks is increased.

Full Mode, Half Mode

The stack controller 30 selects a drive mode of the full mode or the half mode of the fuel cell system 100 according to load power required by the load 50. The full mode represents a drive mode for driving both the first fuel cell stack 11 and the second fuel cell stack 12 when great load power is to be used. The half mode represents a drive mode for driving one of the first fuel cell stack 11 and the second fuel cell stack 12 when small load power is to be used and there is no need to drive all of the fuel cell stacks 11 and 12.

When the first fuel cell stack 11 is driven in the full mode or the half mode, as described in the balance mode, the stack controller 30 detects the current amount output by the first fuel cell stack 11 to estimate performance of the first fuel cell stack 11, and determines output power of the first fuel cell stack 11 corresponding to the performance of the first fuel cell stack 11. When the second fuel cell stack 12 is driven, the stack controller 30 detects the current amount output by the second fuel cell stack 12 to estimate performance of the second fuel cell stack 12, and determines output power of the second fuel cell stack 12 corresponding to performance of the second fuel cell stack 12.

When the first fuel cell stack 11 is not driven in the half mode, the stack controller 30 controls power of the first fuel cell stack 11 to not be converted by the first DC/DC converter 21. The stack controller 30 transmits a first balance signal (Vdac1) of a set or predetermined level to the first DC/DC converter 21 to turn off the first DC/DC converter 21. For example, when the voltage at the first node N1 is 5V and the first balance signal (Vdac1) is applied as a voltage that is greater than the voltage (Vstack1) of the first fuel cell stack 11 by 5V, 0V is generated at the second node N2, and the output signal of 2.5V that is a differential value between the reference voltage (Vref) of 2.5V and the second node N2 is transmitted to the switch controller 130. Upon receiving the output signal of 2.5V, the switch controller 131 closes the switch S1 to prevent power from being output to the first node N11 from the first fuel cell stack 11. When the second fuel cell stack 12 is not driven, the stack controller 30 transmits a second balance signal (Vdac2) of a set or predetermined level to the second DC/DC converter 22 to turn off the second DC/DC converter 22.

Compared to the system using a single fuel cell stack that uses a large membrane electrode assembly (MEA) for high power, the fuel cell system 100 according to the embodiment of the present invention uses a plurality of fuel cell stacks to easily replace the fuel cell stack of which performance is deteriorated, uses a fuel supply device for a small volume, and supply the fuel to the fuel cell stack uniformly. Further, the fuel cell system 100 is driven by the half mode in the case of low load power to prevent unneeded high voltage and improve lifespan of the fuel cell stack.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, it will be appreciated to those skilled in the art that various modifications are made and other equivalent embodiments are available. Accordingly, the actual scope of the present invention must be determined by the spirit of the appended claims, and equivalents thereof.

What is claimed is:

1. A fuel cell system for supplying power to a load, comprising:
a plurality of fuel cell stacks;
a plurality of DC/DC converters coupled to the plurality of fuel cell stacks; and
a stack controller for estimating performance of the respective fuel cell stacks according to current amounts of the plurality of fuel cell stacks, and for controlling power converting efficiency of the respective DC/DC converters according to the performance of the fuel cell stacks to control output power generated by the fuel cell stacks.

2. The fuel cell system of claim 1, wherein
each of the DC/DC converters comprises:
a first comparator for outputting a differential value between a voltage of a corresponding fuel cell stack of the fuel cell stacks and a corresponding balance signal;
a power transformer comprising a switch for receiving the voltage of the corresponding fuel cell stack, for generating output power by converting the voltage of the corresponding fuel cell stack according to a switching operation of the switch, and for supplying power to the load connected to an output end;
a first dividing resistor comprising a first end connected to the output end of the power transformer;
a second dividing resistor comprising a first end connected to a second end of the first dividing resistor and a second end connected to an output end of the first comparator;
a second comparator for outputting a differential value between a voltage at a node to which the first dividing resistor and the second dividing resistor are connected and a reference voltage; and
a switch controller for controlling a duty of the switch according to an output signal of the second comparator.

3. The fuel cell system of claim 2, wherein
the reference voltage represents a set voltage corresponding to the voltage at the node to which the dividing resistor and the second dividing resistor are connected when performance of the fuel cell stack is normal.

4. The fuel cell system of claim 1, further comprising
a plurality of current sensors for measuring current amounts of the fuel cell stacks to transmit an analog current amount signal to the stack controller.

5. The fuel cell system of claim 4, wherein
the stack controller comprises:
an analog-digital converter for converting the analog current amount signal into a digital current amount signal;
a processor for estimating performance of the fuel cell stacks based on the digital current amount signal, and for generating a digital balance signal for power converting efficiency of the DC/DC converters according to performance of the fuel cell stacks; and
a digital analog converter for converting the digital balance signal into an analog balance signal and for transmitting the analog balance signal to the DC/DC converters.

6. The fuel cell system of claim 1, wherein
the stack controller is configured to drive part of the fuel cell stacks according to load power required by the load.

7. A fuel cell system comprising:
a current sensor for generating a current amount signal by measuring a current amount of a fuel cell stack;
a stack controller for estimating performance of the fuel cell stack according to the current amount signal, and for outputting a balance signal to control output power of the fuel cell stack according to performance of the fuel cell stack; and
a DC/DC converter for controlling power converting efficiency according to the balance signal.

8. The fuel cell system of claim 7, wherein
the DC/DC converter comprises:
a first comparator for outputting a differential value between a voltage of the fuel cell stack and the balance signal;
a power transformer comprising a switch for receiving a voltage of the fuel cell stack, and for converting the voltage of the fuel cell stack according to a switching operation of the switch to generate output power at a first node to which a load is connected and to supply power to the load;
a first dividing resistor comprising a first end connected to the first node and a second end connected to a second node;
a second dividing resistor comprising a first end connected to the second node and a second end connected to an output end of the first comparator;
a second comparator for outputting a differential value between a voltage at the second node and a reference voltage; and
a switch controller for controlling output power of the power transformer according to an output signal of the second comparator.

9. The fuel cell system of claim 8, wherein
the reference voltage represents a set voltage corresponding to the voltage at the second node when performance of the fuel cell stack is normal.

10. A method for driving a fuel cell system, comprising:
generating a current amount signal by measuring a current amount of a fuel cell stack;
estimating performance of the fuel cell stack according to the current amount signal;
generating a balance signal for controlling output power of the fuel cell stack according to performance of the fuel cell stack; and
controlling power converting efficiency of a DC/DC converter connected to the fuel cell stack according to the balance signal.

11. The method of claim 10, wherein
the controlling of power converting efficiency of the DC/DC converter comprises:
outputting a first differential value by comparing the balance signal and a voltage of the fuel cell stack;
outputting a second differential value by comparing a reference voltage and a voltage generated at a second node by a voltage difference between the first differential value and a voltage that is converted from the voltage of the fuel cell stack and is output to a first node connected to a load; and
controlling the voltage output to the first node according to the second differential value.

12. The method of claim 11, wherein
the reference voltage represents a set voltage corresponding to a voltage at the second node when performance of the fuel cell stack is normal.
